(19) United States
(12) Patent Application Publication
(10) Pub. No.: US 2006/0014555 A1
(43) Pub. Date: Jan. 19, 2006

(54) Method and apparatus for determining whether a talkgroup is occupied

(76) Inventor: John Paszkat, Toronto (CA)

Correspondence Address: MOTOROLA, INC., 1303 EAST ALGONQUIN ROAD, IL01/3RD, SCHAUMBURG, IL, 60196, US

(21) Appl. No.: 10/894,081

(22) Filed: Jul. 19, 2004

(51) Int. Cl. H04B 7/00

(52) U.S. Cl. 455/518; 455/519

(57) ABSTRACT

A method and system for informing a subscriber unit in a trunked communication system of whether a talkgroup is occupied. The method and apparatus receive a request to communicate with the trunked communication system and select a talkgroup of the trunked communication system. The method and system also communicate with a system controller to transmit information about the subscriber unit comprising at least the selected talkgroup. Further, the method and system determine whether the selected talkgroup is occupied by one or more subscriber units in the trunked communication system and indicate the determination of whether the selected talkgroup is occupied to the subscriber unit.

### FIELD OF THE INVENTION

The present invention relates generally to radio communication systems and in particular, to the field of trunked communication systems with talkgroups.

### BACKGROUND OF THE INVENTION

Trunked communication systems generally have many talkgroups. A user of the trunked communication system may have many talkgroups to choose from, but does not have knowledge of whether there are other users or the number of other users on the same talkgroup. Users prefer to use a talkgroup that is being used (also known as “occupied”) by others for a number of reasons. One reason is that using an occupied talkgroup may provide information about others and events occurring in the area. A second reason is that using an occupied talkgroup may provide a level of comfort to users in sparsely populated, such as rural, areas or at off-peak times, such as at night. In such situations, a talkgroup with only one user may present a safety issue. A third reason is that users with colleagues in the same talkgroup may share information necessary to provide assistance. For example, in a police system, police officers on the same talkgroup can keep track of colleagues and provide quick assistance if necessary. Because of all these reasons, it is necessary to provide an indication of whether a talkgroup is occupied.

Currently, users listen for other communications on a talkgroup to determine whether the talkgroup is occupied. This is not a reliable way to find out if the talkgroup is occupied because other users in the talkgroup may be listening and not transmitting any communications. Users may periodically transmit “anyone out there” to try to find out if a talkgroup is occupied, but this is time consuming and efficient if a user needs to quickly determine whether the talkgroup is occupied or not.

While there are ways to determine whether a talkgroup is occupied or not, the current methods are not reliable, are inefficient, and are relatively unsatisfactory. Accordingly, there exists a need for a better method and apparatus for determining whether a talkgroup is occupied.

### BRIEF DESCRIPTION OF THE DRAWINGS

A preferred embodiment of the invention is now described, by way of example only, with reference to the accompanying figures in which:

FIG. 1 is a block diagram illustrating a typical trunked communication system in accordance with the invention.

FIG. 2 is a flow diagram illustrating the method for determining whether a talkgroup is occupied in accordance with the invention.

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements.

### DETAILED DESCRIPTION OF THE PREFERRED EMBODIMENT

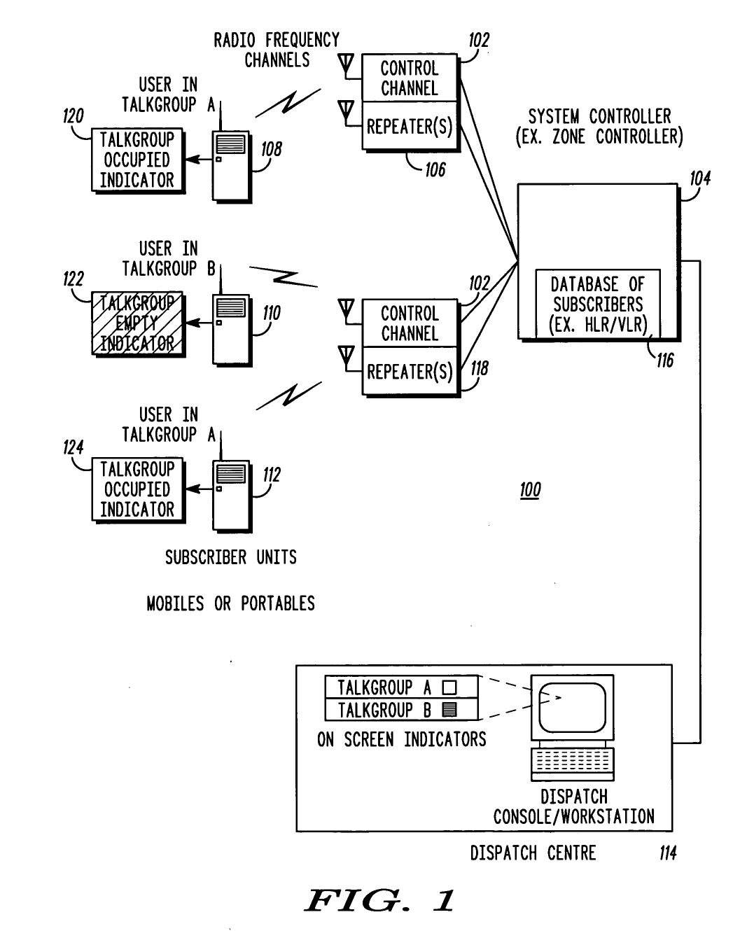

FIG. 1 is a block diagram of an exemplary trunked communication system 100. The subscriber units 108, 110, 112 which are a part of the trunked communication system 100 communicate over control channel 102 with a central resource such as a system controller 104 in order to receive status and control information from the system controller 104. The subscriber units 108, 110, 112 are typically mobile or portable devices and are also known in the art as “radios.” Further, subscriber units are characterized by a talkgroup identifier where a talkgroup is a group of subscriber units that share a radio frequency channel in the trunked communication system 100. Subscriber units with the same talkgroup identifier are able to communicate with each other and are able to monitor conversations between users in the same talkgroup whereas subscriber units with different talkgroup identifiers are not able to communicate with each other. For example in FIG. 1, subscribers 108, 112 are in the same talkgroup, namely talkgroup A, and are able to communicate with each other and monitor conversations in talkgroup A whereas subscriber 110 is in talkgroup B and is not able to communicate with subscribers 108, 112 or monitor conversations in talkgroup A.

The system controller 104 acts as the system coordinator and is responsible for assigning subscriber units 108, 110, 112 to different repeaters 106, 118 (also known as channels) so that they may communicate amongst each other. Each repeater 106, 118 has an associated control channel 102 where the associated control channel may be on a unique frequency or similar frequency. The system controller 104 is also responsible for knowing where each of the subscriber units are located (i.e. what voice channel and/or what site) and for controlling other features typically found in a modern trunked communication system (e.g. handling phone patches, coordinating groups of radios in emergency situations, etc.). Further, the system controller 104 has a database 116 for keeping track of the subscribers. Typically, the database 116 keeps track of subscriber units and information relating to the subscriber units, such as IDs, talkgroup identifiers, and site location. For example in FIG. 1, the database 116 may contain information of subscriber unit 108 such as the subscriber unit's ID, that subscriber unit 108 is in talkgroup A and that subscriber unit 108 is associated with repeater 106. Further, the information in the database 116 may be updated as the subscriber units 108, 110, 112 change talkgroups and move in the trunked communications system 100. Further yet, the typical system controller 104 includes a main processing unit such as a computer with appropriate control software that controls the operation of controller 104. Also normally included with controller 104 is a dispatch center 114. The dispatch console 114 allows dispatchers to communicate with the system subscriber units. The dispatch console 114 may also include a dispatch console or workstation to provide information about the trunked communications system 100.

Communications between the subscriber units 108, 110, 112 and the system controller 104 can be of two directions, inbound and outbound. The signals that are sent from the system controller 104 to the subscriber units 108, 110, 112 over the control channel 102 are typically called outbound signaling communications. The control signals going from subscriber units 108, 110, 112 to the system controller 104 are called inbound signaling communications. Outbound signaling communications inform the subscriber units 108, 110, 112 when to change channels automatically so as to communicate with other members in the same talkgroup over an assigned voice channel 106 which has been assigned by the system controller 104.

An example of a typical trunked communication begins when a subscriber unit (e.g. 108) enters a repeater (e.g. 106) coverage area. The subscriber unit may initiate a communication by pressing PTT (push to talk) which sends a request for a voice channel 106 to the system controller 104. In an exemplary embodiment, the request includes information about which talkgroup the subscriber unit has selected, e.g. for subscriber unit 108, talkgroup A has been selected. Once the request is received at the system controller 104, the system controller 104 registers the subscriber unit with the repeater site by assigning a voice channel (e.g. voice channel on repeater 106) to the subscriber unit 108 and by updating the database of subscribers with information about the subscriber unit 108. The system controller 104 sends an acknowledgement and an over-the-air message to the subscriber unit 108 with information as to whether the selected talkgroup is occupied or not. In response to the received messages, the subscriber unit provides an indicator to the user of whether the selected talkgroup is occupied or not. In an exemplary embodiment, the dispatch console also provides an indication in the dispatch centre as to the relationship between subscriber units in the trunked communication system 100 and their associated talkgroups.

Further, as the subscriber unit moves in the trunked communication system 100, the system controller 104 updates the database 116 with information about the subscriber unit and the talkgroup that the subscriber unit has selected. For example, if subscriber unit 108 moves from coverage in the trunked communication system 100 where coverage is provided by repeater 106 to where coverage is provided by repeater 118, the database 116 is updated with this new information. Also, if the subscriber unit 108 changes talkgroups, for example from talkgroup A to talkgroup B, then the database 116 is also updated with this new information.

An exemplary embodiment of the present invention provides an indicator on the subscriber unit, such as 108, 110, 112, to provide a sign that the selected talkgroup is occupied or not. The indicator may be visual or audible. Further, the indicator may be programmed where an “on,” such as a light, indicates that the talkgroup is not occupied or programmed where an “on,” such as a light, indicates that the talkgroup is occupied. For example in FIG. 1, there is an LED visual indicator 120 that shows a user of subscriber unit 108 that the selected talkgroup, namely talkgroup A, is occupied, since subscriber unit 112 is also in talkgroup A. Another example in FIG. 1, there is an LED visual indicator 122 that shows a user of subscriber unit 110 that he selected talkgroup, namely talkgroup B, is not occupied. Such information may encourage the user of subscriber unit 112 to select another talkgroup or contact a dispatcher at the dispatch centre 114 for further assistance.

There are a number of variations of the indicator that are within the scope of the present invention. One variation is an indicator that displays the number of users in the talkgroup. Another variation is an indicator that displays the type of users in the talkgroup. An example is a display that indicates whether the users are subscriber units or dispatchers. Yet another variation, is an indicator that suggests an occupied talkgroup if the user has selected an unoccupied talkgroup.

In an exemplary embodiment, the subscriber unit has an internal programmable delay which allows the user's talkgroup selection to be settled before the indicator is broadcast. Thus, there is a delay between the time a user selects a talkgroup and the time that the subscriber unit transmits the selected talkgroup to the system controller.

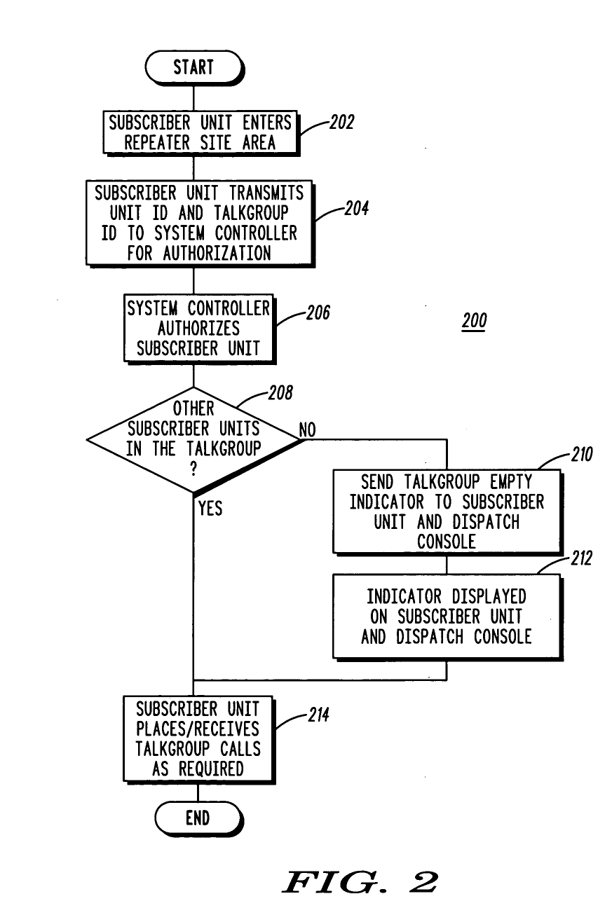

Referring now to FIG. 2, a flow diagram showing the steps taken by one of the subscriber units in accordance with an exemplary embodiment of the invention is shown. In step 202, the subscriber unit (for example a subscriber unit in talkgroup “A”) enters a repeater site area (for example repeater 106). In step 204, the subscriber unit transmits a unit id and talkgroup id to the system controller 104 for authorization. This information comes to the system controller 104 as an inbound signaling communication. The information is then used by the system controller 104 to update a database of subscribers 116 which stores information on all the subscriber units in the system 100 and their current talkgroup affiliations. An automatic affiliation routine may also be performed by the subscriber units when they leave a service area, leave a talkgroup, or leave a repeater site. In step 206, the system controller 206 authorizes the subscriber unit for communication.

In step 208, the system controller 104 determines whether other subscriber units are in the talkgroup. If there are other subscriber units in the talkgroup, then in step 214 the subscriber unit places/receives talkgroups. If there are no other subscriber units in the talkgroup, then in step 210, the system controller 104 sends the subscriber unit an indication that there are no other subscriber units in the talkgroup. Further, in step 210, an indication that there are no other subscriber units in the talkgroup is sent to the dispatch centre 114. In step 212, the subscriber unit provides an indication to the user that there are no other subscriber units in the selected talkgroup. Further, in step 212, an indication that there are no other subscriber units in the talkgroups is shown on a dispatch console or workstation at the dispatch centre 114. This indication may be by on screen indicators or other similar indication.

In summary, the present invention provides a method for determining whether a talkgroup is occupied. It allows the user to instantly know whether others are using the same talkgroup. By having such knowledge, users can “look out for each other” and provide assistance as necessary. Users will know if others have left the talkgroup and are currently in an unoccupied talkgroup. This invention greatly increases the safety of personnel, particularly for those operating in remote coverage areas of the trunked communication system 100, or at late hours.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. For example, the subscriber unit and/or the base radio may comprise a storage medium having stored thereon a set of instructions which, when loaded into a hardware device (e.g., a microprocessor), causes the hardware device to perform the following functions of the present invention. The present invention can be implemented in at least one of hardware, firmware and/or software. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

It should be noted that the terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

We claim:

1. A method for informing a subscriber unit in a trunked communication system of whether a talkgroup is occupied, the method comprising the steps of:
receiving at a system controller a request to communicate with the trunked communication system;
selecting a talkgroup of the trunked communication system;
communicating with the system controller to transmit information about the subscriber unit comprising at least the selected talkgroup;
determining whether the selected talkgroup is occupied by one or more subscriber units in the trunked communication system; and
indicating the determination of whether the selected talkgroup is occupied to the subscriber unit.

2. The method of claim 1 further comprising the step of indicating the determination of whether the selected talkgroup is occupied to a dispatch centre.

3. The method of claim 1 wherein the step of receiving occurs after the subscriber unit waits a programmable amount of time before sending the selected talkgroup to the system controller.

4. The method of claim 1 wherein the step of determining further comprises the sub-step of receiving new talkgroup information at the system controller from the one or more subscriber units in the trunked communication system.

5. The method of claim 1 wherein the step of indicating further comprises the sub-step of transmitting a message to the subscriber unit of a number of users in the selected talkgroup.

6. The method of claim 5 wherein the step of indicating is either in audible or visual form.

7. The method of claim 1 wherein the step of indicating further comprises the sub-step of displaying at the subscriber unit information on whether the selected talkgroup is occupied.

8. The method of claim 7 wherein the information is a number of users.

9. The method of claim 7 wherein the information is a type of user.

10. The method of claim 1 wherein the step of indicating further comprises the sub-step of suggesting an occupied talkgroup if the user has selected an unoccupied talkgroup.

11. In a trunked communication system having a system controller and a plurality of subscriber units affiliated with a talkgroup, a method for determining whether a talkgroup is occupied, the method comprising the steps of:
at a subscriber unit:
receiving a message by the system controller with information about a number of users using the talkgroup; and
indicating the number of users using the talkgroup to a user of the subscriber unit.

12. The method of claim 11 further comprising the step of delaying an amount of time before communicating a selected talkgroup to the system controller, whereby the amount of time is programmable.

13. In a trunked communication system having a system controller and a plurality of subscriber units affiliated with a talkgroup, a method for determining whether a talkgroup is occupied, the method comprising the steps of:
at the system controller:
determining if at least one subscriber unit of the plurality of subscriber units affiliated with the talkgroup is using a talkgroup; and
transmitting a message to one or more of the plurality of subscriber units with information about a number of users using the talkgroup.

14. The method of claim 13 further comprising the step of transmitting a message to a dispatch centre with information about a number of users using the talkgroup.

15. A system for determining whether a talkgroup is occupied comprising:
a receiver for receiving messages which communicate information about a number of users in the talkgroup of a trunked communication system;
a selector which chooses the talkgroup by locking onto a specific frequency in the trunked communication system;
a transmitter to communicate the selected talkgroup to a system controller of the trunked communication system; and
an indicator which signals the information about the number of users to the user of the system,
wherein the operation of the receiver, the selector, the transmitter, and the indicator are controlled by a processor.

16. The system of claim 15 wherein the indicator further comprises a display which conveys to a user of the system the information about the number of users in visual form.

17. The system of claim 15 wherein the indicator further comprises a speaker which conveys to a user of the system the information about the number of users in audible form.

18. The system of claim 15 further comprising a timer which delays the time when the indicator signals the information about the number of users to the user of the system.

19. The system of claim 15 wherein the processor conveys information about an occupied talkgroup if an unoccupied talkgroup is selected.

20. A system for determining whether a talkgroup is occupied comprising:
means for receiving at a system controller a request to communicate with the trunked communication system;
means for selecting a talkgroup of the trunked communication system;
means for communicating with the system controller to transmit information about the subscriber unit comprising at least the selected talkgroup;
means for determining whether the selected talkgroup is occupied by one or more subscriber units in the trunked communication system; and
means for indicating the determination of whether the selected talkgroup is occupied to the subscriber unit.
